(19) United States
(12) Patent Application Publication
(10) Pub. No.: US 2006/0011558 A1
(43) Pub. Date: Jan. 19, 2006

(54) Disinfecting system and method for liquid systems

(76) Inventors: Forrest B. Fencl, Valencia, CA (US); David L. Witham, Valencia, CA (US)

Correspondence Address: CISLO & THOMAS, LLP, 233 WILSHIRE BLVD, SUITE 900, SANTA MONICA, CA, 90401-1211, US

(21) Appl. No.: 11/182,315

(22) Filed: Jul. 15, 2005

Related U.S. Application Data
(60) Provisional application No. 60/588,529, filed on Jul. 15, 2004.

(51) Int. Cl. C02F 1/32

(52) U.S. Cl. 210/748

(57) ABSTRACT

Exemplary embodiments provided herein include a system and method for disinfecting liquids, such as water in cooling towers. One embodiment may include one or more ultraviolet lamp assemblies submerged in a reservoir. Such lamp assemblies may be hermetically sealed from water in order to function properly and safely when submerged. Another embodiment may include a sleeve of quartz or UV transparent glass or both. The ultraviolet lamp, and the power lead may be protected from water. The sleeve may be sealed at each end, or a domed sleeve may be used with a watertight seal at the other end. Yet further embodiments may include a UV-transparent polymer material or both.

### CROSS-REFERENCE TO RELATED APPLICATION

This application claims priority to U.S. Provisional Application No. 60/588,529, filed on Jul. 15, 2004, the entire contents of which are hereby incorporated by reference.

### BACKGROUND

Many installations of heating, ventilating, air conditioning, and refrigeration equipment (HVAC&R) may utilize cooling towers to cool a refrigerant, which is recirculated within the HVAC&R system. Water may be introduced at the top of a series of aerators, slats or other media, and this water and a stream of moving air may be utilized to cool the refrigerant flowing within the coils. As used herein the term “refrigerants” may include Freon, water, glycol ammonia and other fluids. When this cooling water reaches the bottom of the cooling tower, it may be collected in a sump or reservoir. The water may be recirculated through a pump and piped distribution system, and may be used over and over.

Cooling towers may be open to environmental elements and may be subject to contamination. This recycled water may provide an ideal breeding ground for microbes, such as bacteria and mold. In addition, microbes and other contaminants may be introduced through the coiling air or by exposure to the elements and contaminants, such as bird droppings, and the like. Further, the source of the water may provide contamination. Consequently the cooling water may become quite contaminated. Maintaining these systems and keeping the water clean may be difficult. While mold, fungus and yeast are common in terms of fouling and efficiency, another real concern in cooling towers is bacteria with the focus on Legionella. This concern is not only for the counts in the tower water reservoir but more specifically, the counts in the drifting mist as contained in the towers discharge air. Industry experience suggests that when a tower is shut down, bacteria counts potentially increase at an appreciable level for at least several days. Because of this, weekend and night hours are of concern as they could total as much as 120 hours of shut down or 7200 minutes and using an ideal bacteria division rate of one every 20 minutes, this could become 5.7 C 10¹⁷ or 571,000,000,000,000,000 microorganisms! In instances where shutdown may be greater than five days without routine service and maintenance programs could be for concern.

In some systems this water may be treated with caustic, expensive and harmful chemicals, or filtered to reduce the contamination. This may be expensive, corrosive and may create other concerns and/or problems.

What is needed is a system and method to help treat and disinfect the water within the large reservoir, which can be the major portion of the water in a cooling tower system at any one time.

### SUMMARY

Exemplary embodiments provided herein include a system and method for disinfecting liquids, such as water in a cooling tower. One embodiment may include one or more ultraviolet lamp assemblies submerged in a reservoir. Such lamp assemblies may be hermetically sealed from water in order to function properly and safely when submerged.

Another embodiment may include an outer lamp envelope, a sleeve of quartz or UV transparent glass. The ultraviolet lamp and the power lead may be protected from water. The sleeve may be sealed at each end, or a domed sleeve may be used with a watertight seal at the other end. Yet further embodiments may include a UV-transparent polymer material or both.

### BRIEF DESCRIPTION OF THE DRAWINGS

FIG. 1 is a cross section of a cooling tower system including UV lamps, according to an exemplary embodiment.

FIG. 2 is a UV lamp according to one embodiment, with a protective coating.

FIG. 2 is a UV lamp according to one embodiment, with protective quartz sleeve.

### DETAILED DESCRIPTION

The description set forth below in connection with the appended drawings is intended as a description of exemplary embodiments and is not intended to represent the only forms in which the embodiments may be constructed and/or utilized. The description also sets forth the functions and the sequence of steps for constructing and operating the illustrated embodiments. However, it is to be understood that the same or equivalent functions and sequences may be accomplished by different embodiments that are also intended to be encompassed within the spirit and scope of the invention.

A device incorporating a UVC lamp may be placed in water or other liquids found in the reservoirs of cooling towers and the like. The lamp may be hermetically sealed and protected for use under water or other liquids. The UV lamp may be coated with a UV transparent polymer material or protected in a quartz or transparent glass sleeve, or both, according to exemplary embodiments. The device may incorporate stands, which may allow the lamps to be placed in the water reservoir and maintain a determined level in the reservoir, which might not be at the bottom or at the liquid's surface. By directly irradiating the water within the reservoir, microbial growth and other organic matter may be reduced and/or controlled in an efficient and sufficient manner. Water may be irradiated, and microbes introduced by the air stream may also be inactivated or destroyed. Direct UVC irradiation of this water may control microbial growth and may be effective against bacteria and mold. In particular, concerns over diseases, such as Legionella as well as others, may be reduced, decreased or eliminated.

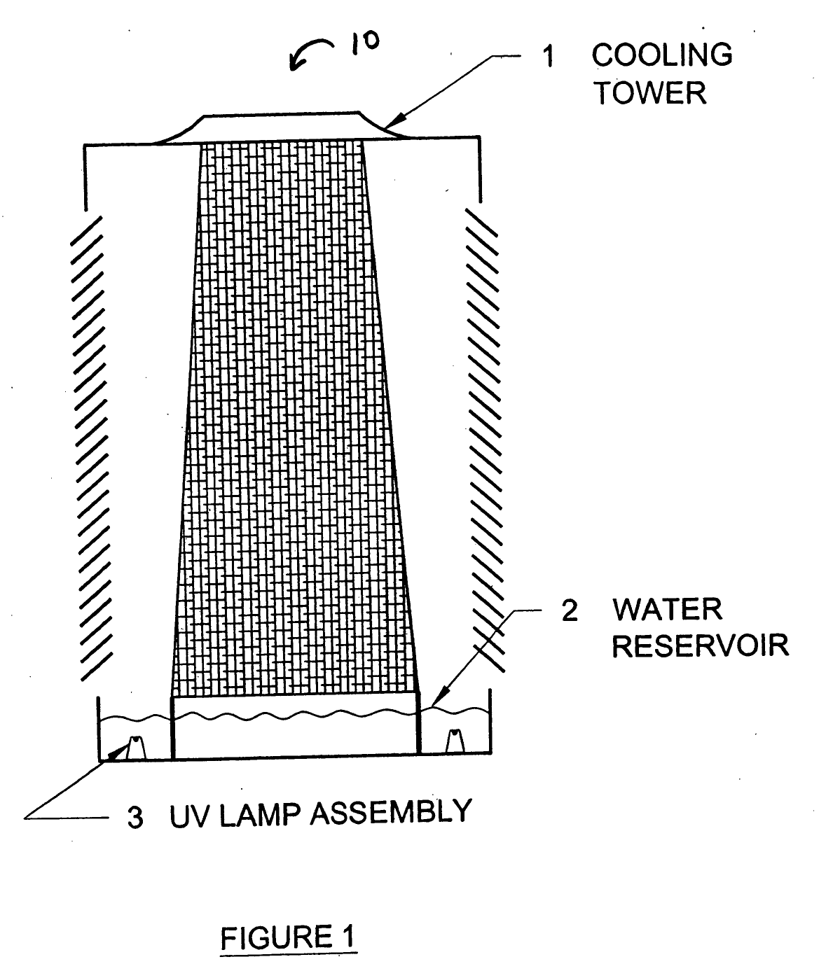

FIG. 1 shows an exemplary embodiment, generally at 10. System 10 may include an electromagnetic energy source 3, such as a UV lamp, positioned adjacent to, or within a cooling tower, and the like. In a normal operation of the cooling tower, 1, water may be pumped from the reservoir, 2, to the top of the cooling tower where it trickles down, or is sprayed down over the heat-exchanging portion of the cooling tower. Water then may recollect in a reservoir. The reservoir may be the source of contamination introduced through air within the system, and contamination within the water itself.

Electromagnetic or UV lamp assemblies, 3, which may be placed within the water reservoir, are shown. UV lamps may be in the C range, and may emit wavelengths of approximately 254 nm, which may be close to an optimal germicidal ultraviolet lamp wavelength. UV lamps may also be used which generate a portion of their energy at about 185 nm. This adds the benefit of reducing organics within the water. Further, broad band UV lamps may be used which include a variety of UV wavelengths. UV lamp assembly 3 may include a support, which supports the lamp and may keep it submerged at a desired level within the water reservoir.

The placement and number of the lamp assemblies may be such that disinfection of the liquids, water and other portions of the system, is optimized. Characteristics of the system may dictate the placement and number of assemblies to be used.

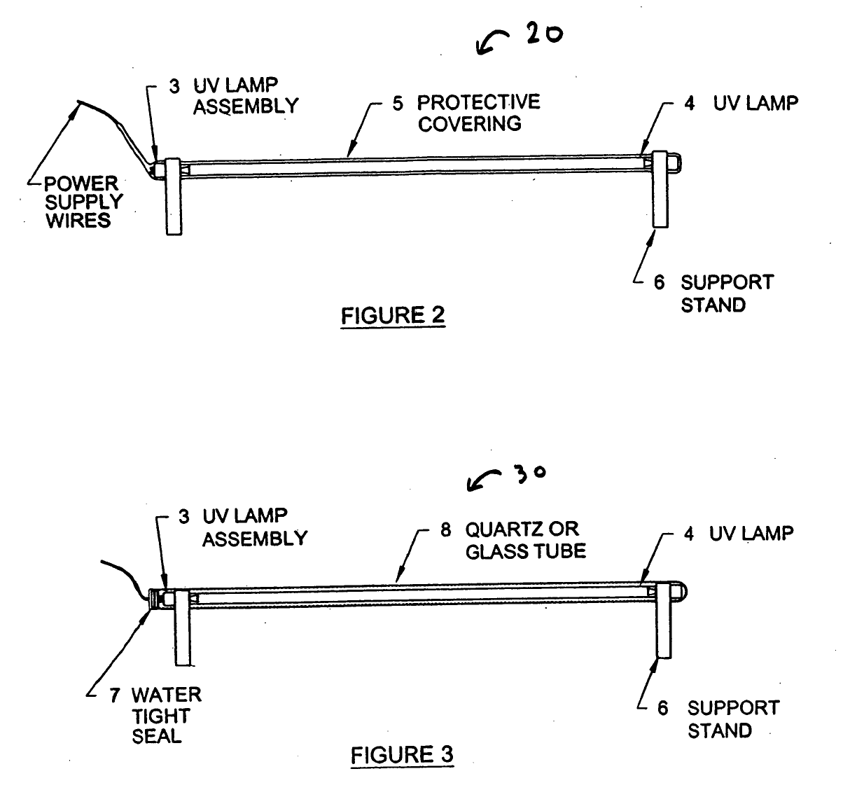

Referring to FIG. 2, one embodiment of the UV lamp utilized in this system and method is shown, generally at 20. System 20 may include a UV lamp assembly 3, which may include one or more support stands 6. Support stands may be configured to support and retain the lamp in the water reservoir. System 20 may also include a UV lamp bulb 4, which may be protected with a UV transparent polymer material 5 over its complete length, including the power supply wires. The lamp may be hermetically sealed against water and the ballast or power supply, which supplies the lamp, can be remotely located to increase system longevity, and reduce the likelihood of failure due to liquids entering the system.

In FIG. 3, another embodiment of a device for this system and method is shown, generally at 30. System 30 may include a UV lamp assembly 3, and support stand 6. The lamp may be installed within a quartz or UV transparent glass tube 8. A watertight seal 7, may be installed in the end of this glass tube to seal the power supply wire to the lamp to reduce the likelihood that water will enter the system, and reduce the likelihood of a fatal lamp failure within the system.

The method to disinfect the water within the cooling tower is to provide and position one or more of these electromagnetic assemblies in appropriate, optimal positions at a determined depth in the water level to provide adequate UV, 254 nm dosage to the surrounding water. The entire reservoir may be continuously disinfected or designed to operate intermittently. Furthermore other positions and numbers of the electromagnetic sources may be utilized, including locations adjacent the system, as desired.

In closing, it is to be understood that the exemplary embodiments described herein are meant to be merely illustrative of the principles. Other modifications that may be employed are within the scope of the various disclosed embodiments. Thus, by way of example, but not of limitation, alternative configurations may be utilized in accordance with the teachings herein. Accordingly, the drawings and description are illustrative and not meant to be a limitation thereof.

What is claimed is:

1. A method to treat water or a coolant in the reservoir of a cooling tower in order to control microbial growth or organic material agglomeration, comprising:
submerging one or more ultraviolet lamp assemblies in the reservoir,
wherein said lamp assemblies are hermetically sealed from water in order to function properly and safely when submerged.

2. The method of claim 1, wherein the ultraviolet lamp assembly is hermetically sealed with a UV transparent polymer, which totally encapsulates the lamp, wire leads between lamp ends and the power leads connecting it to allow for underwater operation.

3. The method of claim 1 wherein the UV lamp may utilize 185 nm, 254 nm, a combination of 185 nm and 254 nm, or a broad spectrum of UV wavelengths.

4. The method of claim 1, wherein the ultraviolet lamp assembly incorporates a sleeve of quartz or UV transparent glass to protect ultraviolet lamp and the power lead from water, wherein the sleeve may be sealed at each end, or a domed sleeve may be used with a watertight seal at the other end.

5. A system for reducing organic matter, microbial growth and proliferation in liquids, comprising:
an electromagnetic energy source; and
a support coupled to said electromagnetic energy source, and placed adjacent to a cooling tower reservoir.

6. The system of claim 5, further comprising a UV transparent polymer which encapsulates the electromagnetic energy source.

7. The system of claim 5, further comprising a sleeve of quartz adjacent said electromagnetic energy source.

8. The system of claim 5, further comprising UV transparent glass adjacent said electromagnetic energy source.

9. The system of claim 8, wherein said glass is domed.

10. A method of disinfecting liquids and surfaces in a cooling tower or the like, comprising:
providing an electromagnetic energy source; and
positioning said electromagnetic energy source adjacent a liquid system to inhibit microbial growth and organic matter agglomeration in a liquid and on surfaces.

11. The method of claim 10, wherein said electromagnetic energy source comprises an ultraviolet lamp assembly.

12. The system of claim 10, wherein said electromagnetic energy source comprises a UV transparent polymer which encapsulates the electromagnetic energy source.

13. The system of claim 10, wherein said electromagnetic energy source comprises a sleeve of quartz adjacent said electromagnetic energy source.

14. The system of claim 10, wherein said electromagnetic energy source comprises UV transparent glass adjacent said electromagnetic energy source.

15. The system of claim 14, wherein said glass is domed.

16. The method of claim 10 wherein the UV lamp may utilize 185 nm, 254 nm, a combination of 185 nm and 254 nm, or a broad spectrum of UV wavelengths.

17. A method of disinfecting liquids and surfaces in a cooling tower or the like, comprising:
providing means for inhibiting microbial growth; and
positioning said means for inhibiting microbial growth and organic matter adjacent to a liquid system.

18. The method of claim 17, wherein said means for inhibiting microbial growth comprises an electromagnetic energy source.

19. The method of claim 17, wherein said means for inhibiting microbial growth comprises an ultraviolet lamp assembly.

20. The system of claim 18, wherein said electromagnetic energy source comprises a UV transparent polymer which encapsulates the electromagnetic energy source.

21. The system of claim 18, wherein said electromagnetic energy source comprises a sleeve of quartz adjacent said electromagnetic energy source.

22. The system of claim 18, wherein said electromagnetic energy source comprises UV transparent glass adjacent said electromagnetic energy source.

23. The system of claim 22, wherein said glass is domed.

24. The method of claim 17 wherein the UV lamp may utilize 185 nm, 254 nm, a combination of 185 nm and 254 nm, or a broad spectrum of UV wavelengths.
